(19) United States
(12) Patent Application Publication
(10) Pub. No.: US 2012/0152405 A1
(43) Pub. Date: Jun. 21, 2012

(54) FLUID FILLING ASSEMBLY

(75) Inventor: Tod L. Hetzel, Bartonville, IL (US)

(73) Assignee: Caterpillar Inc., Peoria, IL (US)

(21) Appl. No.: 13/222,364

(22) Filed: Aug. 31, 2011

Related U.S. Application Data
(60) Provisional application No. 61/424,757, filed on Dec. 20, 2010.

(51) Int. Cl. B65B 3/00; B23P 17/00

(52) U.S. Cl. 141/98; 29/525.01

(57) ABSTRACT

The present disclosure relates to a fluid filling assembly with improved assembly and serviceability features. The fluid filling assembly comprises one or more bosses, a fill neck, a retainer plate, at least one fastener, a fill cap and a gasket. The one or more bosses are present at a top surface of a fluid tank. The gasket and the fill neck are coaxial with an opening present at the top surface of the fluid tank. The retainer plate is present above the fill neck where the position of the fill neck is retained with the aid of the one or more fasteners and one or more washers. The fill cap is removably coupled to the fill neck. In an embodiment of the present disclosure, a method to assemble the fluid filling assembly is disclosed.

### CLAIM FOR PRIORITY

The present application claims priority from U.S. Provisional Application Ser. No. 61/424,757, filed Dec. 20, 2010, which is fully incorporated herein.

### FIELD OF INVENTION

The present disclosure relates to the field of an assembly for fluid filling. More specifically, the present disclosure relates to an improved assembly for fluid filling which is easy to manufacture, assemble and service.

### BACKGROUND OF THE INVENTION

It is known in the art that a conventional fluid filling assembly comprises a fill neck which is made of brass. While assembling the conventional fluid filling assembly, the fill neck needs to be positioned accurately with respect to an orifice present at a top surface of a coolant tank. Thereafter, the fill neck is brazed to the top surface of the coolant tank. Brazing is more susceptible to defects when compared to state of the art welding techniques. Also, brass material used in the fill neck is soft and probability of part failure is high. Hence, when the fill neck of the conventional fluid filling assembly fails, either the coolant tank is replaced or the failed fill neck is removed and a new fill neck is brazed at the top surface of the coolant tank. This process consumes time and economically not viable. Further, using a spring loaded, quarter turn stamped cap in the conventional fluid filling assembly increases cost as well as susceptibility to failure.

Hence, there is a requirement of an advanced fuel filling assembly addressing the above mentioned limitations.

### SUMMARY OF THE INVENTION

An objective of the present disclosure is to provide a fluid filling assembly for a fluid tank which is easy to manufacture and service. Another objective of the present disclosure is to provide an efficient method for assembling the fluid filling assembly for the fluid tank.

In an embodiment of the present disclosure, the fluid filling assembly comprises a fill neck, a retainer plate. This embodiment further comprises a fill cap.

One or more bosses are positioned at a top surface of the fluid tank. A gasket is provided at the top surface of the fluid tank in accordance with the position of an opening in the fluid tank. The gasket is positioned between the fluid tank and the fill neck. Further, the retainer plate is positioned above the fill neck. A desired orientation of the fill neck is retained, where the movement of the fill neck is locked with the aid of at least one fastener. The retainer plate is configured to retain the fill neck. In one embodiment the fill neck comprises an overflow tube to indicate an overflow of the fluid. In another embodiment of the present disclosure, the fill neck further comprises a relief at the sides of the overflow tube to shed spillover fluid.

In another embodiment of the present disclosure, a method for assembling the fluid filling assembly is provided. The one or more bosses are welded at required positions around the opening present at the top surface of the fluid tank. The gasket and the fill neck are positioned about the opening present at the top surface of the fluid tank. Thereafter, the retainer plate is coupled to the fluid tank. The one or more fasteners with the one or more gaskets are used to couple the retainer plate with the fluid tank. Thereafter, the fill cap is removably coupled with the fill neck. In an embodiment of the present disclosure, a threading arrangement is made in the fill neck to screw the fill cap. In another embodiment of the present disclosure, the fill cap is made of materials such as plastic or the like. In yet another embodiment of the present disclosure, the fill cap is applicable in the fluid tank holding pressure of lesser than or equal to 15 PSI.

In an embodiment of the present disclosure, the fluid tank is a coolant tank and the fluid is a coolant. In another embodiment of the present disclosure, the fluid tank is a shunt tank.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present disclosure.

FIG. 1 is an exploded view of a fluid filling assembly, in accordance with an embodiment of the present disclosure;

FIG. 2 is a perspective view of a partially assembled fluid filling assembly 100, in accordance with one embodiment of the present disclosure;

FIG. 3 is a perspective view of a partially assembled fluid filling assembly 100, in accordance with an embodiment of the present disclosure;

FIG. 4 is a perspective view of a fluid filling assembly 100, in accordance with an embodiment of the present disclosure;

FIG. 5 is a perspective view of a fluid filling assembly 100, in accordance with an embodiment of the present disclosure; and

FIG. 6 is a flow diagram describing the steps involved in assembling a fluid filling assembly, in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present disclosure.

### DETAILED DESCRIPTION

Before describing the embodiments in detail in accordance with the present disclosure, it should be observed that these embodiments reside primarily in the apparatus of the fluid filling assembly and the method for assembling it. Accordingly, the method steps and the system components have been represented to show only those specific details that are pertinent for an understanding of the embodiments of the present disclosure, and not the details that will be apparent to those with an ordinary skill in the art.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising. Further, the terms “coupling”, “coupled”, “attaching” or “attached” or any other variation therefore are used interchangeably in this document and refers to same meaning and scope.

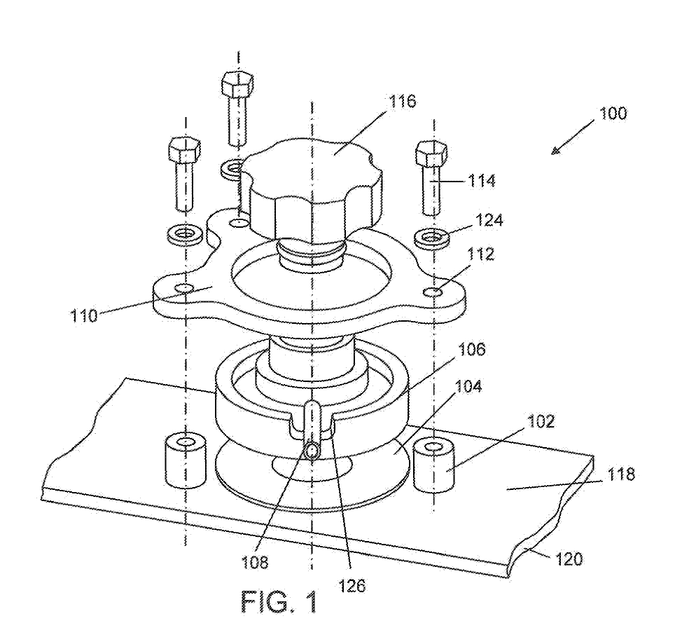

FIG. 1 is an exploded view of a fluid filling assembly 100, in accordance with an embodiment of the present disclosure.

The fluid filling assembly 100 comprises one or more bosses 102, a gasket 104, a fill neck 106, an overflow tube 108, a retainer plate 110, at least one fastener 114 and a fill cap 116.

The fluid filling assembly 100 is assembled with a fluid tank 120. In one embodiment, the fluid filling assembly 100 is mounted on a top surface 118 of the fluid tank 120. The top surface 118 comprises an opening 122. The fluid filling assembly is aligned with the opening 122 and thereafter assembled with the fluid tank 120.

One or more bosses 102 are attached with the top surface 118 of the fluid tank 120. The one or more bosses 102 can be welded with the top surface 118 of the fluid tank 120. In an alternate embodiment, the one or more bosses 102 can be an integral part of the top surface 118. In other words, the one or more bosses can be molded with the top surface 118.

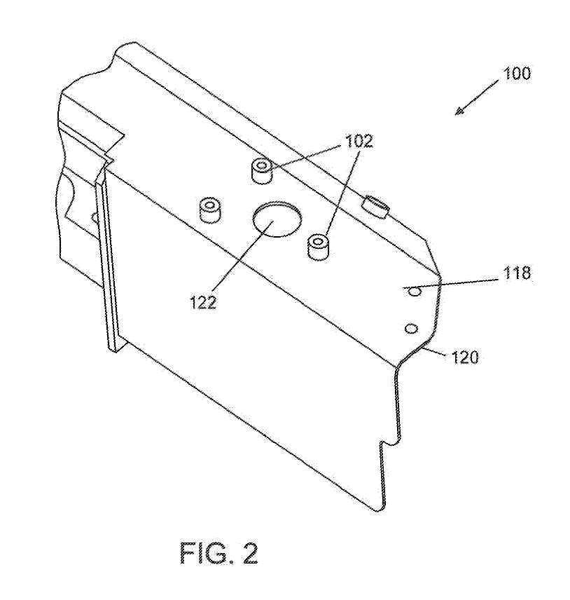

The gasket 104 is positionable on the opening 122, such that the opening and the gasket are co-axial. Further, the fill neck 106 and the retainer plate 110 are arranged coaxially with respect to the opening 122. The opening 122 is further shown in accordance with FIG. 2. The gasket 104 present between the fill neck 106 and the top surface 118 of the fluid tank 120 provides for seal between the fill neck 106 and the top surface 118. Further, the fill neck 106 comprises the overflow tube 108. The fill neck 106, before assembly, can be rotated and aligned in a desired position to point the overflow tube 118 in a desired direction. The direction of the overflow tube is based on the requirements and design of the fluid tank. In an embodiment of the present disclosure, the fill neck 106 is made of materials such as brass or the like.

Furthermore, the retainer plate 110 is provided above the fill neck 106. The retainer plate 110 is coupled with the fluid tank 120. The retainer plate 110 is coupled to the fluid tank 120 by using at least one fastener 114. The retainer plate 110 comprises holes 112 to facilitate coupling with the fluid tank 120 at the bosses 102. In an embodiment of the present disclosure, the bosses 102 are threaded internally, and the at least one fastener 114 is a set of bolts, that are fastened at bosses 102. The fasteners 114 and washers 124 are configured to facilitate coupling of the retainer plate 110 to the fluid tank 120 by threading on to the bosses 102. In an embodiment of the present disclosure, the fasteners 114 and the washers 124 are of M8 (Metric-8) dimension.

Further, the fill cap 116 is removably coupled with the fill neck 106. In an embodiment of the present disclosure, the fill cap 116 is externally threaded and the fill neck 106 is internally threaded to enable removable coupling.

FIG. 2 is a perspective view of a partially assembled fluid filling assembly 100, in accordance with an embodiment of the present disclosure.

The partially assembled fluid filling assembly 100 comprises the opening 122, and the bosses 102 the attached to the fluid tank 120. In an embodiment of the present disclosure, the mode of attaching the bosses 102 to the fuel tank 120 is welding. The bosses 102 are attached at desired positions at the top surface 118 of the fluid tank 120. In the present embodiment of the disclosure, for an illustrative purpose, three bosses 102 are used. However, based on design requirement number of the bosses 102 can be increased or decreased. In an embodiment of the present disclosure, the bosses 102 are threaded internally.

The opening 122 can be a hole stamped on the top surface 118 of the fluid tank 120.

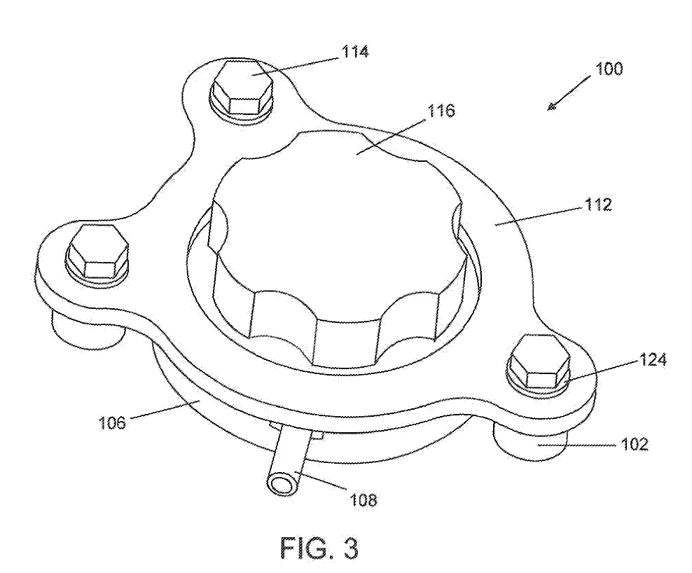

FIG. 3 is a perspective view of a partially assembled fluid filling assembly 100, in accordance with an embodiment of the present disclosure.

The partially assembled fluid filling assembly 100 comprises the fill neck 106 positioned on the top surface 118 of the fluid tank 120. The fill neck 106 is positioned with respect to the position of the opening 122 present in the fluid tank 120. The overflow tube 108 orientation is adjustable to a desired position. The overflow tube 108 is configured to indicate overflow of fluid when fluid level in the tank, during operation, reaches above the capacity of the fluid tank 120. The fill cap 116 is removably coupled to the fill neck 106. In an embodiment of the present disclosure, the fill cap 116 is made of materials such as plastic.

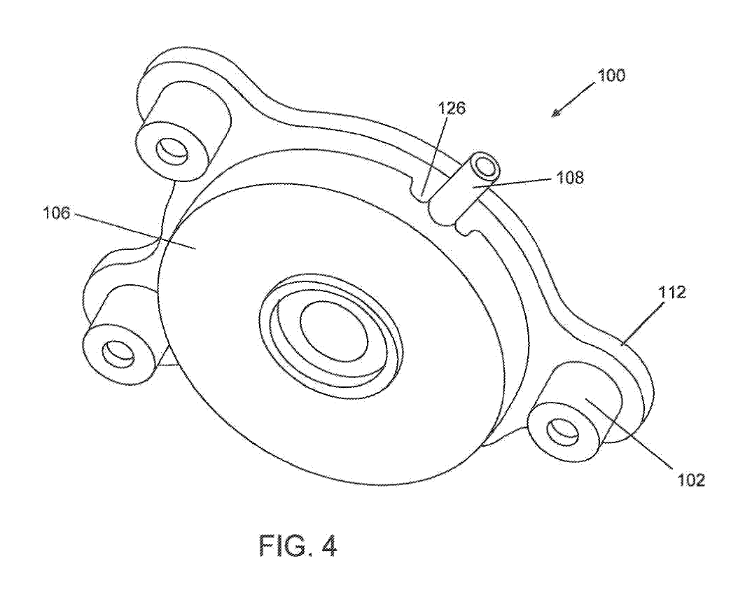

FIG. 4 is a perspective view of a fluid filling assembly 100, in accordance with an embodiment of the present disclosure.

The perspective view of the fluid filling assembly 100 provides an assembled view. The fluid filling assembly 100 comprises the bosses 102, the gasket 104, the fill neck 106 with the overflow tube 108, the retainer plate 110 with the holes 112, the fasteners 114 and the fill cap 116.

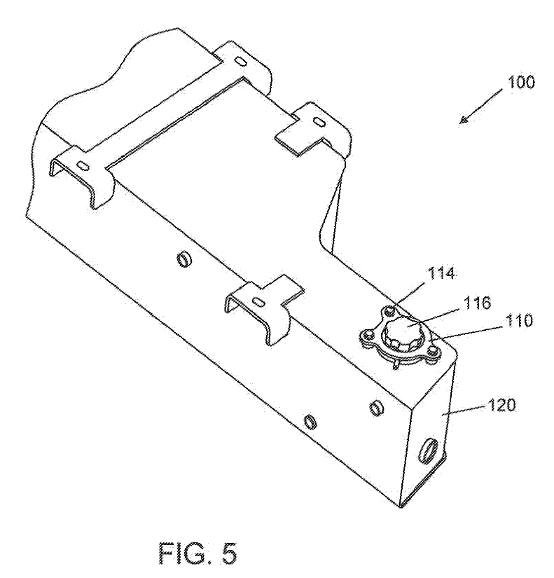

FIG. 5 is a perspective view of a fluid filling assembly 100, in accordance with an embodiment of the present disclosure.

The fluid filling assembly 100 comprises the retainer plate 110 coupled to the fluid tank 120. The retainer plate 110 is configured to retain or lock the fill neck 106 in a position with respect to the opening 122. The fasteners 114 and the washers 124 are configured to facilitate retention or locking of the fill neck 106 to the fluid tank 120.

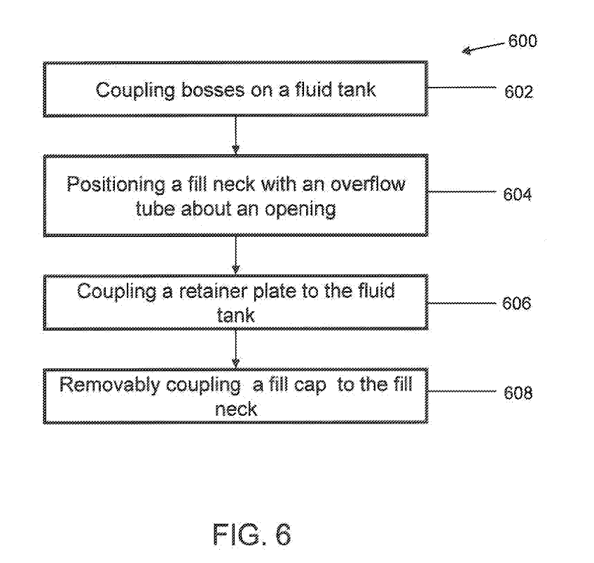

FIG. 6 is a flow diagram 600 describing a method involved in assembling a fluid filling assembly, in accordance with an embodiment of the present disclosure.

Elements mentioned in the following paragraph are labeled in conjunction with elements of FIG. 1

The method 600 comprises the step 602 of coupling the bosses 102 to the top surface 118 of the fluid tank 120. In an embodiment of the present disclosure, the bosses 102 are coupled to the top surface 118 of the fluid tank 120 by welding. Further, it can be appreciated by the person skilled in the art bosses 102 can be coupled to the top surface 118 of the fluid tank 120 by fasteners, bolts, rivets and the like. In an alternate arrangement, the bosses can be formed as an integral part of the top surface 118, by molding the bosses during casting of the fluid tank 120.

Step 604 denotes an essential step of positioning the fill neck 106 about the opening 122 in the fluid tank 120. The fill neck 106 can be positioned about the opening 122 in the fluid tank 120 for any desired orientation of the overflow tube 108. In other words, the fill neck 106 can be rotated in a suitable direction to position the overflow tube 108 based on the design of the fluid tank. Moreover, the provided arrangement allows a user to rotate and position the overflow tube as desired.

Furthermore, the gasket 104 is also positioned between with the fill neck 106 and the opening 122 of the fluid tank 120. The gasket 104 can prevent fluid leakage between the fill neck 106 and the opening 122 of the fluid tank 120.

Thereafter, at step 606 the retainer plate 110 is coupled to the fluid tank 120 above the fill neck 106. The retainer plate 110 is coupled to the fluid tank 120 by attaching at least one fastener 114 to the one or more bosses 102. In an embodiment, the retainer plate 110 can be directly attached to the fluid tank 120 by one or more fastener 114. Further, the coupling of the retainer plate 110 to the fluid tank 120 above the fill neck 106 facilitate the retention of the position of the fill neck 106 about the opening 122 in the fluid tank 120. At, step 608 the fill cap 116 is removable coupled to the fill neck 106. In an embodiment of the present disclosure, threads present on fill cap 116 and threads present on the fill neck 106 facilitates the coupling of the fill cap 116 and the fill neck 106.

A significant advantage of the method involved in assembling the fluid filling assembly disclosed is assembling of the fill neck without metal working process such as welding or the like is involved. The provided method and assembly reduces susceptibility of failure of components used in the fluid filling assembly and eases the serviceability.

Various embodiments of the present disclosure offer one or more advantages. The present disclosure provides for a fluid filling assembly. It is expected that one of ordinary skill, notwithstanding possibly significant effort and many design choices motivated by, for example, available time, current technology and economic considerations, when guided by the concepts and principles disclosed herein, will be readily capable of generating such products with minimal experimentation.

In the foregoing specification, the disclosure and its benefits and advantages have been described with reference to specific embodiments. However, one of ordinary skill in the art would appreciate that various modifications and changes can be made without departing from the scope of the present disclosure, as set forth in the claims below. Accordingly, the specification and figures are to be regarded in an illustrative rather than a restrictive sense, and all such modifications are intended to be included within the scope of the present disclosure. The benefits, advantages, solutions to problems, and any element(s) that may cause any benefit, advantage or solution to occur or become more pronounced are not to be construed as critical, required or essential features or elements of any or all the claims. The disclosure is defined solely by the appended claims, including any amendments made during the pendency of this application, and all equivalents of those claims, as issued.

What is claimed is:

1. A fluid filling assembly for a fluid tank, comprising:
a fill neck having an overflow tube, the fill neck being positionable about an opening in the fluid tank for a desired overflow tube position; and
a retainer plate configured to retain the fill neck in a desired orientation about the opening in the fluid tank.

2. The fluid filling assembly according to claim 1, wherein the retainer plate is coupled with the fluid tank.

3. The fluid filling assembly according to claim 2, wherein the coupling of the retainer plate with the fluid tank being facilitated by at least one fastener.

4. The fluid filling assembly according to claim 1, further comprising a fill cap, the fill cap being removably coupled with the fill neck.

5. The fluid filling assembly according to claim 1, comprising a gasket positionable between the fluid tank and the fill neck.

6. A fluid filling assembly for a fluid tank, comprising:
a fill neck having an overflow tube, the fill neck being positionable about an opening in the fluid tank for a desired overflow tube position; and
a retainer plate configured to retain the fill neck in a desired orientation about the opening in the fluid tank,
at least one fastener configured to couple the retainer plate with the fluid tank.

7. The fluid filling assembly according to claim 6, further comprising a fill cap, the fill cap being removably coupled with the fill neck.

8. The fluid filling assembly according to claim 6, comprising a gasket positionable between the fluid tank and the fill neck.

9. A method for assembling a fluid filling assembly for a fluid tank, the method comprising:
positioning a fill neck on the fluid tank, the fill neck having an overflow tube, the fill neck being positionable about an opening in the fluid tank for a desired overflow tube position; and
coupling a retainer plate to the fluid tank, the retainer being configured to retain the fill neck in a desired orientation about the opening in the fluid tank.

10. The method according to claim 9, wherein the coupling of the retainer plate with the fluid tank being facilitated by at least one fastener.

11. The method according to claim 9, wherein removably coupling the fill neck with a fill cap.

12. The method according to claim 9, further comprising positioning a gasket between the fluid tank and the fill neck.
